(19) United States
(12) Patent Application Publication
(10) Pub. No.: US 2026/0172376 A1
(43) Pub. Date: Jun. 18, 2026

(54) CUSTOMIZED MESSAGING ACROSS MULTIPLE COMMUNICATION CHANNELS

(71) Applicant: Twilio, Inc., San Francisco, CA (US)

(72) Inventors: Chan How Law, San Francisco, CA (US); Allison Glotfelty, San Francisco, CA (US); Aditya Kammardi Sathyanarayan, San Francisco, CA (US); Triet Minh Kha, Millbrae, CA (US); Michael Wong, San Francisco, CA (US)

(21) Appl. No.: 18/986,460

(22) Filed: Dec. 18, 2024

(51) Int. Cl. H04L 51/046; H04L 51/56

(52) U.S. Cl. CPC H04L 51/046; H04L 51/56

(57) ABSTRACT

Methods and systems for customized messaging across multiple communication channels are provided. A request to transmit a message associated with a user to one or more recipient devices is received. A communication resource pool associated with the user is identified. The communication resource pool indicates multiple communication channels associated with the user, each associated with a priority ranking. A communication channel is determined for transmittal of the message based on the priority rankings. One or more content items corresponding to the determined communication channel are identified. The message including the identified content items is transmitted to the one or more recipient devices via the determined communication channel.

### TECHNICAL FIELD

Aspects and embodiments of the disclosure relate to computer software, and more specifically, to systems and methods for customized messaging across multiple communication channels.

### BACKGROUND

Services and/or applications leverage messaging services (e.g., short message service (SMS), multimedia messaging service (MMS), rich communication service (RCS), etc.) in communicating with customers. In some instances, services and/or applications can transmit messages to customers via one or more communication channels associated with such messaging services, such as a SMS messaging channel, a MMS messaging channel, a RCS messaging channel, and so forth.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1 illustrates an example system architecture, in accordance with some embodiments of the disclosure.

FIG. 2 illustrates an example resource pool engine, in accordance with some embodiments of the disclosure.

FIG. 3 is a flow diagram of an example method for configuring a communication resource pool associated with a user, in accordance with some embodiments of the disclosure.

FIG. 4 illustrates example communication resource pool data, in accordance with some embodiments of the present disclosure.

FIG. 5 is a flow diagram of an example method for customized messaging across multiple communication channels, in accordance with some embodiments of the present disclosure.

FIG. 6 is a block diagram illustrating an exemplary computer system, in accordance with some embodiments of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as shortform message service (SMS) messages, multimedia messaging service (MMS) messages, rich communication service (RCS) messages, instant message (IM) messages, etc., to and from devices via various communication channels. A communication channel can refer to a form of communication that uses one or more of a particular protocol, a particular underlying technology or is provided by a particular service provider. Different communication channels can refer to different forms of communication that can use one or more of different communication protocols, different underlying technologies (e.g., SMS vs IP), or are provided by different service providers that offer services, software or hardware (or a combination thereof) through which messages can be exchanged between recipient devices. For instance, the SaaS platform may send a text message (e.g., SMS message) to a recipient device using a communication channel, such as a telecommunications carrier network or send an instant message to a recipient device using an IM communication channel (e.g., via an application programming interface (API)). Examples of channels can include Public Switched Telephone Network (PSTN) based channels such as SMS or MMS, Internet Protocol (IP) based channels, and proprietary channels (e.g., proprietary social media messaging applications).

Some communication services offered by the SaaS platform can be subject to messaging constraints, which can limit the ability of a platform to transmit certain types of messages to recipient devices. For example, SMS messages (e.g., which are transmitted via a SMS channel) may be subject to content limitations relating to the maximum number of characters allowed per message, a type of content supported by the message, and so forth. In another example, MMS or RCS messages may only be transmitted to recipient devices that are capable (or include components that are capable) of receiving such messages and/or via a network having sufficient bandwidth to support such messages. In yet another example, governmental regulations of certain jurisdictions may not allow for messages associated with certain messaging services to be transmitted to recipient devices located within such jurisdictions (e.g., while other messages associated with other messaging services are allowed). In light of the above, users (e.g., a service and/or an application) of the platform may utilize multiple communication services for communication with other users (e.g., customers of the service and/or application), such that messages that may not be transmitted to a recipient device using a particular communication service (e.g., due to one or more messaging constraints for such service) can be transmitted to the recipient device via another communication channel (e.g., that is not subject to such messaging constraints).

With the numerous communication services offered by the SaaS platform, it can be difficult for users to coordinate and customize the routing outgoing communications for specific recipient devices. For example, a user may want to transmit an RCS message to customers, which includes complex content features, such as a high-resolution image, a high-resolution video, file sharing, read receipts, typing indicators, etc. Data pertaining to specific recipient devices (e.g., a messaging capability the recipient devices) may not be readily available or may be outdated, and therefore the user and/or the platform may be unaware of which recipient devices are capable of receiving the RCS message. In conventional systems, the platform may transmit the RCS message to recipient devices of all customers for which the message is intended and, upon receiving a notification that the transmittal of the RCS message to recipient devices that are incapable of receiving RCS messages has failed, notify the user of such failure. In some instances, the user may then provide a SMS message (or other message type that such recipient devices are capable of receiving) to the platform for transmittal to such devices, which is then transmitted to such devices via a SMS communication channel. As indicated above, identifying and transmitting messages to recipient devices via messaging services subject to messaging constraints can consume a large number of system resources (e.g., processing cycles, network bandwidth, etc.). This can make such resources unavailable for other processes, which reduces the overall efficiency and throughput and increases the overall latency of the system.

Aspects of the disclosure address the above-mentioned and other deficiencies by providing techniques for customized messaging across multiple communication channels of a communication services platform (e.g., a SaaS platform). The platform can provide a user of the platform with access to tools to create or otherwise define a communication resource pool associated with the user. A user of the platform can be an entity representing an organization and can include, for example, a person, an application or service. A communication resource pool (also referred to as a sender pool) refers to a collection of messaging services utilized by the user for communication with other users (e.g., customers of the service or application). In some embodiments, the platform can provide the user with access to a user interface (UI) associated with creating or defining the communication resource pool (e.g., via a client device associated with the user). The user can provide an indication of the messaging services utilized by the user and/or a communication identifier (e.g., a phone number, etc.) associated with each of the messaging services via the UI.

In some embodiments, the platform can determine a priority ranking associated with each communication channel of the messaging services of the communication resource pool. A priority ranking can indicate a priority of a respective channel for transmittal of messages to recipient devices via such channel (e.g., over other channels associated with the communication resource pool). In an illustrative example, an RCS channel of the communication resource pool can be associated with a higher priority ranking than a SMS channel of the communication resource pool. This can indicate that, when possible, messages associated with the user should be sent to recipient devices as RCS messages and/or via the RCS channel, instead of being sent as SMS messages and/or via the SMS channel. In some embodiments, the user can provide an indication of a priority ranking for each communication channel via the UI, as described herein. In other or similar embodiments, the platform can determine the priority ranking for each communication channel of the messaging services (e.g., based on historical or experimental data associated with the platform). Further details regarding priority rankings of communication channels and transmission of messages according to such priority rankings are provided herein.

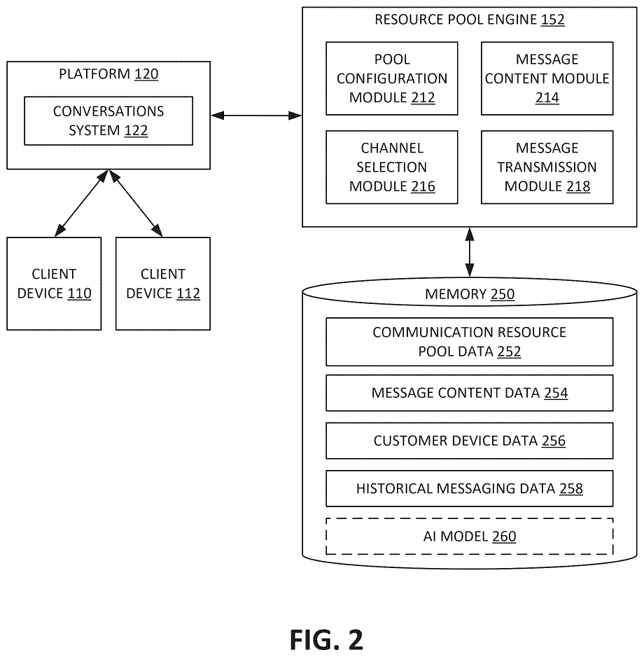

In some embodiments, the user can be additionally or alternatively provided with an option to supply message content data. The message content data can include one or more content items that each correspond to a communication channel of a respective messaging service. In an illustrative example, the message content data can include one or more image content items, one or more video content items, etc. that correspond to a logo or a brand associated with the user. As will be seen below, such content items may be included with messages directed to recipient devices based on a communication channel for which the messages are transmitted. Further details regarding creating and/or defining the communication resource pool and the message content data are provided herein with respect to FIGS. 2-4.

The platform can receive a request to transmit a message associated with the user to one or more recipient devices. In some embodiments, the message can include textual data representing the content of the message. The platform can identify a communication resource pool associated with the user and can determine a communication channel of the communication resource pool for transmittal of the message. In some embodiments, the platform can determine the communication channel for transmittal of the message based on the priority ranking associated with each of the communication channels. For example, the platform can identify the communication channel having the highest priority ranking and select such communication channel for transmittal of the message. In other or similar embodiments, the platform may obtain data indicating a message capability of a respective recipient device and/or historical messaging data associated with the respective recipient device. The message capability can indicate whether the respective recipient device is capable of receiving messages via the communication channel associated with the highest priority ranking. The historical messaging data can indicate a preferred communication channel of an end user of the respective recipient device based on historical messages transmitted to such recipient device. In some embodiments, the platform may select a communication channel associated with a lower priority ranking for transmittal of the message in view of the message capability and/or the historical messaging data, as described herein.

Upon determining a communication channel for transmittal of the message, the platform can identify one or more content items of the message content data that correspond to the determined communication channel. In an illustrative example, the system can select an RCS communication channel for transmittal of the message and can identify one or more content items (e.g., image content items, video content items, etc.) of the message content data that can be included in the message sent via the RCS communication channel. In another illustrative example, the system can select an instant message (IM) communication channel for transmittal of the message and can identify one or more content items of the message content data that can be included in the message sent via the IM communication channel (e.g., which may be the same or different from content items that could be sent via the RCS channel). Upon identifying the one or more content items corresponding to the determined communication channel, the platform can transmit the message including the identified content item(s) to the one or more recipient devices via the determined communication channel. For example, the platform can transmit the message as an RCS message including the image content items and/or the video content items via the RCS channel to the recipient device(s).

Aspects of the present disclosure provide techniques for enabling users of a SaaS platform to communicate with customers via customized messages across multiple communication channels. As described herein, a user can create or otherwise define the communication resource pool, which is used by the platform to identify a communication channel for transmittal of messages when a request to transmit such messages is received. The platform can identify the communication channel for transmission of the messages based on a priority ranking for each channel and, in some instances, based on a message capability and/or historical messaging data for a respective recipient device, thus improving the likelihood that the message will be successfully transmitted to the recipient device and/or the user of the recipient device will engage with the message. Further, the user can provide message content data (e.g., representing a brand package of the user) which includes content items that can be included in the message according to the type of communication channel determined for transmittal of the messages. Thus, the messages that are transmitted via the platform can include content that is customized for the user in accordance with the communication channel that is determined for transmission to a recipient device. In view of the above, embodiments of the present disclosure reduce the overall number of messages transmitted to recipient devices, which reduces the consumption of system resources (e.g., processing cycles, network bandwidth, etc.), thereby improving the overall efficiency, throughput, and latency of the system.

It can be appreciated that aspects of the disclosure are described as pertaining to RCS messages and SMS messages for the purpose of illustration, rather than limitation. In some embodiments, the aspects of the disclosure can be applied to other types of messages and/or other areas including, but not limited to other communication services of the SaaS platform.

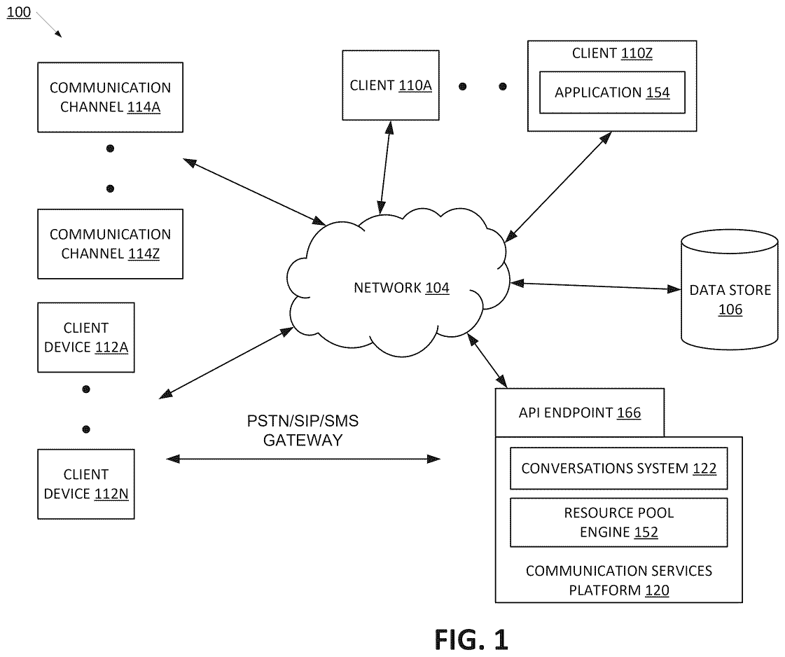

FIG. 1 illustrates an example system architecture 100, in accordance with some embodiments of the disclosure. The system architecture 100 (also referred to as “system” herein) includes a communication services platform 120, a data store 106, client devices 110A-110Z connected to a network 104, client devices 112A-112Z communicatively coupled to communication services platform 120, and communication channels 114A-114Z coupled to the network 104 (or otherwise communicatively coupled to other elements of the system 100).

In embodiments, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 106 is a persistent storage that is capable of storing data as well as data structures to tag, organize, and index the data. Data store 106 may be hosted by one or more storage devices, such as main memory, magnetic or optical storage-based disks, tapes or hard drives, NAS, SAN, and so forth. In some embodiments, data store 106 may be a network-attached file server, while in other embodiments data store 106 may be some other type of persistent storage such as an object-oriented database, a relational database, and so forth, that may be hosted by communication services platform 120 or one or more different machines coupled to the communication services platform 120 via the network 104.

The client devices 110A-110Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some embodiments, client devices 110A through 110Z may also be referred to as “user devices.”

In some embodiments, a client device, such as client device 110Z, can implement or include one or more applications, such as application 154 (also referred to as “client application 154” herein) executed at client device 110Z. In some embodiments, application 154 can be used to communicate (e.g., send and receive information) with communication services platform 120. In some embodiments, application 154 can implement user interfaces (e.g., graphical user interfaces (GUIs)) that may be webpages rendered by a web browser and displayed on the client device 110Z in a web browser window. In another embodiment, the user interfaces of client application 154 may be included in a stand-alone application downloaded to the client device 110Z and natively running on the client device 110Z (also referred to as a “native application” or “native client application” herein).

In some embodiments, client devices 110 can communicate with communication services platform 120 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing application 154. In some embodiments, the communication services platform 120 can respond to the requests from the client device 110Z by using one or more API responses using an application layer protocol. Similarly, communication services platform 120 can communicate with one or more communication channels 114A-114Z using API function calls.

In some embodiments, one or more of client devices 110 can be identified by a uniform resource identifier (URI), such as a uniform resource locator (URL). For example, communication services platform 120 can send an API call to client device 110Z addressed to a URL specific to the client device 110Z. In some embodiments, the communication services platform 120 can be identified by a URI. For instance, the API call sent by a client device 110 to communication services platform 120 can be directed to the URL of communication services platform 120.

In some embodiments, the APIs used to access the conversations system 122 of the communication services platform 120 can be different from the APIs used to access the resource pool engine 152 of communication services platform 120. In some embodiments, the APIs used by application 154 executed on a desktop client device (e.g., desktop application) to access the conversations system 122 and/or resource pool engine 152 can be different APIs than the APIs used by application 154 executed on a mobile client device (e.g., mobile application) to access the conversations system 122 and/or resource pool engine 152. In some embodiments, conversations system 122 and resource pool engine 152 can communicate between one another using APIs. In some embodiments, the APIs used to communicate between conversations system 122 and resource pool engine 152 may be private APIs that are not accessible by client devices 110 (or client devices 112).

In some embodiments, client devices 112A-112Z (generally referred to as “client device(s) 112” herein) may be similar to client devices 110. In some embodiments, client devices 112 can include one or more telephony devices. A telephony device can include a Public Switched Telephone Network (PSTN)-connected device, such as a landline phone, cellular phone, or satellite phone, for example. In some embodiments, a telephony device can also include an internet addressable voice device (e.g., non-PSTN telephony device), such as Voice-Over-Internet-Protocol (VOIP) phones, or Session Initiation Protocol (SIP) devices, for example. In some embodiments, a telephony device can include one or more messaging devices, such as a Short Message Service (SMS) network device that, for example, uses a cellular service to exchange SMS messages or Multimedia Messaging Service (MMS) messages.

In some embodiments, the communication services platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, communication services platform 120 may include multiple computing devices that together may include a hosted computing resource, a grid computing resource or any other distributed computing arrangement. In some embodiments, communication services platform 120 may correspond to an elastic computing resource where the allotted capacity of processing, network, storage, or other computing-related resources may vary over time.

In some embodiments, a communication channel can be associated with a service provider (e.g., organizations different from communication services platform 120), that offers services, software or hardware (or a combination thereof) through which messages can be sent to recipient devices. A service provider may be a distinct system from and/or external to the communication services platform 120. Such service provider is referred to herein as a third party service provider or simply a third party. Additionally or alternatively, a service provider may be associated with or otherwise correspond to communication services platform 120. Such service provider is referred to as a first party service provider. In some embodiments, the communication services offered by communication channels 114A-114Z can be integrated into communication services platform 120. In some embodiments, the communication services offered by communication channels 114A-114Z can include messaging services. In some embodiments, messaging services can include one or more of a short messaging service (SMS) offered by an SMS channel, a multimedia messaging service (MMS) offered by an MMS channel, rich business messaging (RBM) offered by an RBM channel, or rich communication services (RCS) offered by an RCS channel or an instant messaging service (e.g., chat messaging) offered by an instant messaging service channel.

In some embodiments, an instant messaging service is different from an electronic mail (email) service. In some embodiments, the communication channels 114A-114Z can include an email channel. In some embodiments, the communication channels 114A-114Z exclude an email channel. In some embodiments, email messages can use a standard protocol for sending and receiving email messages. The standard protocol can be used across different platforms. In some embodiments, instant messages can use protocols specific to a platform that may or may not be compatible with other platforms. In some embodiments, instant messaging can differ from email in that conversations over instant messaging can happen in real-time, while conversations over email are not in real-time.

In some embodiments, communication services platform 120 provides one or more API endpoints 166 that can expose services, functionality or content of the communication services platform 120 to one or more of client devices 110 or communication channels 114A-114Z. In some embodiments, an API endpoint 166 can be one end of a communication channel, where the other end can be another system, such as a client device 110Z or communication channel 114Z. In some embodiments, the API endpoint 166 can include or be accessed using a resource locator, such a universal resource locator (URL), of a server or service. The API endpoint 166 can receive requests from other systems, and in some cases, return a response with information responsive to the request. In some embodiments, HTTP or HTTPS methods can be used to communicate to and from API endpoint 166.

In some embodiments, the API endpoint 166 (also referred to as a “request interface” herein) can function as a computer interface through which communication requests, such as message and/or voice requests, are received and/or created. The communication services platform 120 may include one or more types of API endpoints.

In some embodiments, the API endpoint 166 can include a messaging API and/or voice API whereby external entities or systems can send a communication to create message content and/or request sending of a message and/or request voice services that are provided via voice system 124. The API (e.g., message API and/or voice API) may be used in programmatically creating message content and/or requesting sending of one or more messages and/or requesting the transfer or joining client device(s) to a voice call. In some embodiments, the API is implemented in connection with a multitenant communication service wherein different accounts (e.g., authenticated entities) can submit independent requests. These requests made through the API can be managed with consideration of other requests made within an account and/or across multiple accounts on the communication service.

In some embodiments, the API of the API endpoint 166 may be used in initiating general messaging or communication requests. For example, a messaging request may indicate one or more destination endpoints (e.g., recipient phone numbers), message content (e.g., text and/or media content), and possibly an origin endpoint (e.g., a phone number to use as the “sending” phone number).

In some embodiments, the API of the API endpoint 166 may be any suitable type of API such as a REST (Representational State Transfer) API, a GraphQL API, a SOAP (Simple Object Access Protocol) API, and/or any suitable type of API. In some embodiments, the communication services platform 120 can expose through the API, a set of API resources which when addressed may be used for requesting different actions, inspecting state or data, and/or otherwise interacting with the communication platform.

In some embodiments, a REST API and/or another type of API may work according to an application layer request and response model. An application layer request and response model may use HTTP (Hypertext Transfer Protocol), HTTPS (Hypertext Transfer Protocol Secure), SPDY, or any suitable application layer protocol. Herein HTTP-based protocol is described for purposes of illustration rather than limitation. The disclosure should not be interpreted as being limited to the HTTP protocol. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some embodiments, the API endpoint 166 can include a request instruction module that can be called within an application, script, or other computer instruction execution. For example, a computing platform may support the execution of a set of program instructions where at least one instruction within a script or other application logic is used in specifying a message request and communicating that request.

In some embodiments, the API endpoint 166 can include a console, administrator interface, or other suitable type of user interface. Such a user-facing interface can be a graphical user interface. Such a user interface may additionally work in connection with a programmatic interface.

In some embodiments, a request, such as a message request, can include a data object characterizing the properties of a message. In some embodiments, the communication services platform 120 is associated with message requests that are programmatically initiated (e.g., an application-to-person (A2P) message). In some embodiments, the message request could be one initiated from an inbound received message.

In some embodiments, a request (e.g., message request and/or voice request) can include one or more of one or more destination endpoints, one or more origin endpoints, and message content and/or audio content. In some embodiments, one or more of these properties may be specified indirectly such as through system or account configuration or identifier (e.g., messaging conversation identifier). For example, all messages may be automatically assigned an origin endpoint that is associated with an account. In some embodiments, the message content can include any suitable type of media content including, text, audio, image data, video data, multimedia, interactive media, data, and/or any suitable type of message content.

In an illustrative example, used for illustration rather than limitation, communication services platform 120 can include a Software as a Service (SaaS) platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In some embodiments, communication services platform 120, as noted above, can provide communication services that include, but are not limited to, voice services, messaging services (e.g., SMS services, MMS services, rich business messaging (RBM) services, or rich communication services (RCS)), email services, video services, chat messaging services (e.g., internet-based chat messaging services), virtual artificial intelligence (AI) assistant services, human agent services, or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

In some embodiments, the conversations system 122 can function to interface with one or more communication network(s) and/or service(s) for communication of a conversation (e.g., a messaging conversation, such as SMS, MMS, RCS, and/or chat messaging). In some embodiments, the conversations system 122 can include an interface to one or more carrier-based communication routes used in sending SMS, MMS, RCS, and/or other carrier-based messages. There may be multiple carrier-based communication routes that serve as different optional “routes” when sending communications over a carrier-based network (e.g., a mobile network). The conversations system 122 may additionally or alternatively include an interface to one or more over-the-top (OTT) communication channels which may be offered by a third-party messaging platform (e.g., proprietary social media messaging, messaging applications, etc.).

Routing can refer to directing or managing the path that data, voice calls, or other communications take through a network or system. A route can refer to a communication delivery path, and in some cases is defined by a series of one or more of computers, routers, gateways and/or carrier networks through which the communication is transferred from a source computer to a destination computer (e.g., through which the transmission of a message occurs). For example, the same route may be used to transfer messages using different communication channels, and the same communication channel may be used to transfer messages using different routes. In some example embodiments, different channels correspond to different applications on a recipient device. For example, a smart phone may have one application to handle SMS messages, another application to handle email, and a third application to handle voicemail. Alternatively, some applications may handle multiple communication channels. For example, one application may handle SMS, MMS, and RCS messages.

In some embodiments, when the conversations system 122 elects to send a message using a carrier-based channel, the message is communicated to an appropriate carrier connection for routing to the destination endpoint. Carrier-based channels can use SMPP (Short Message Peer-to-Peer protocol) for communicating to an aggregator or another suitable gateway such that the SMS/MMS message is transferred over a carrier network. Once transmitted to the carrier network, the message can be relayed appropriately to arrive at the intended destination. A message in transit may have multiple routing segments that are used in the delivery to an end destination device.

For example, the conversations system 122 can include an interface to one or more SMS Gateways that enable a computer to send and receive SMS text messages to and from a SMS capable device over the global telecommunications network (normally to a mobile phone). The SMS Gateway translates the message sent and makes it compatible for delivery over the network to be able to reach the recipient. The different SMS gateways (or more generally message gateways) can serve as different route options when the conversations system 122 is determining a channel and/or route to be used for one or more message transmissions.

In some embodiments, SMS Gateways can route SMS text messages to the telco networks via an SMPP interface that networks expose, either directly or via an aggregator that sells messages to multiple networks. SMPP, or Short Message Peer-to-Peer, is a protocol for exchanging SMS messages between Short Message Service Centers (SMSCs) and/or External Short Messaging Entities (ESMEs).

In some embodiments, the destination of a message may be used in determining the candidate message routes (and/or channels). For example, a phone number of a destination endpoint or another identifier associated with the intended recipient of the message may be used to identify the destination network of the intended recipient. Each destination network may be assigned a Mobile Country Code (MCC)/Mobile Network Code (MNC) pair that identifies the specific destination network.

In some embodiments, communication services platform 120 includes a conversations system 122 that can use the phone number associated with the intended recipient of the message to lookup the MCC/MCN pair identifying the destination network. For example, the conversations system 122 can determine the MCC/MNC pair using an MCC/MNC directory that lists the MCC/MNC pair corresponding to each phone number. In some embodiments, the MCC/MNC directory may be stored in a routing provider storage. Alternatively, the MCC/MNC directory may be stored at some other network accessible location. In either case, the conversations system 122 can use the phone number associated with the intended recipient of the message to query the MCC/MNC directory and identify the MCC/MNC pair that identify the corresponding destination network.

In some embodiments, the conversations system 122 can use the MCC/MNC pair retrieved from the MCC/MNC directory to identify candidate routing providers and routes that are available to deliver a message to the destination network identified by MCC/MNC pair. For example, the routing provider storage may include a routing provider directory that lists each MCC/MNC pair serviced by the conversations system 122 and the corresponding routing providers and routes available for use with each MCC/MNC pair. That is, the routing provider directory can list the routing providers and routes that are available to the conversations system 122 to deliver messages to the destination network identified by each MCC/MNC pair listed in the routing provider directory.

In some embodiments, conversations system 122 can include a communication service such as a human agent services that facilitates communication with a live agent. In some embodiments, the communication service can include a virtual AI assistant application. A virtual AI assistant can refer to a software application that uses artificial intelligence (AI) technologies, such as a generative AI model, to perform tasks and provide services for users. The tasks can range from simple administrative functions, like setting reminders and sending messages, to more complex activities, such as providing customer support, helping users manage services or engaging in natural language conversations. In some embodiments, a virtual AI assistant can simulate human-like interactions and perform tasks through natural language processing (NLP) and machine learning algorithms. The virtual AI assistant can function as an intelligent intermediary, capable of understanding, interpreting, and responding to user inputs via text or voice. In some embodiments, the virtual AI assistant can leverage one or more large language models (LLMs) and/or advanced neural network architectures to process complex queries, generate contextually relevant responses, and/or execute commands across various platforms and devices. In some embodiments, the virtual AI assistant can integrate with APIs and databases to retrieve and manipulate data, providing functionalities such as scheduling, information retrieval, and task automation.

In some embodiments, resource pool engine 152 can manage and/or otherwise implement a communication resource pool associated with a user of platform 120 (e.g., a user associated with a client device 110). A communication resource pool refers to a collection of messaging services utilized by the user for communication with other users (e.g., a user associated with a client device 112). Each of the messaging services utilized by the user can correspond to a respective communication channel 114. For example, messaging services of a communication resource pool can include a SMS service offered by a SMS channel, a MMS service offered by an MMS channel, a RCS service offered by an RCS channel, and so forth. In some embodiments, resource pool engine 152 can provide a graphical user interface (GUI) to a client device 110 (e.g., via application 154) which enables the user to select one or more messaging services for inclusion in a communication resource pool associated with the user. In additional or alternative embodiments, the user may also provide message content data indicating one or more content items each associated with a respective messaging service. Upon receiving a request to transmit a message associated with the user to a client device 112, resource pool engine 152 can identify a messaging service of the communication resource pool for transmission of the message and can determine one or more content items of the provided message content data for inclusion in the message transmitted to the client device 112 based on the identified messaging service. Further details regarding resource pool engine 152 and the communication resource pool are provided herein with respect to FIGS. 2-5.

In some embodiments, communication services platform 120 can include a multitenant system. Multitenancy can refer to a mode of operation of software applications where multiple independent instances of one or multiple applications operate in a shared computer environment. In some embodiments, the instances (tenants) can be logically isolated, but physically integrated. The degree of logical isolation can be complete, but the degree of physical integration can vary. The tenants (application instances) can be representations of organizations that obtain access to the multitenant system. The tenants may also be multiple applications competing for shared underlying resources. Multiple organizations can access the resources of communication services platform 120 without any indication that the resources are shared between the multiple organizations. The data of each of the organizations can be logically isolated from one another such that each organization has access to their own data but not the data of other organizations in the multitenant system. In some embodiments, communication services platform 120 can include a single tenant system.

An organization can be an example of an entity, such as a legal entity, which includes multiple people and that has a particular purpose. A non-limiting example of an organization includes a corporation (e.g., authorized by law to act as a single entity or legal entity). In some embodiments, multiple organizations can include one or more organizations that are independent or distinct from the other organizations. For example, a first organization can be corporation A and a second organization can be corporation B. Corporation A can be considered an independent legal entity from corporation B. Each of corporation A and corporation B can make independent decisions and have a different legal or corporate structure.

In some embodiments, a “user” may be represented as a single individual. However, other embodiments of the disclosure encompass a “user” being an entity controlled by a set of users and/or an automated source. For example, a set of individual users federated as one or more departments in an organization may be considered a “user.” In general, functions described in one embodiment as being performed by the communication services platform 120 can also be performed on the client devices 110A through 110Z in other embodiments (and vice versa), if appropriate. In addition, the functionality attributed to a particular component can be performed by different or multiple components operating together. The communication services platform 120 can also be accessed as a service provided to other systems or devices through appropriate APIs.

In some embodiments, an entity (e.g., organization) can be associated with an account (e.g., organizational account) of communication services platform 120. Within the particular account (e.g., organizational account) of the organization, one or more user accounts of the communication services platform 120 may be associated with different users of the organization. In some embodiments, the accounts are organized in a hierarchical structure where the organizational account is the root at the top of the hierarchy and the user accounts are nested under the organizational account.

In some embodiments, communication services platform 120 can provision telephone numbers (e.g., 10-digit long code or short code) to an organization's account and assign the telephone numbers to various user accounts associated with the organization. The assignment of telephone numbers can be flexible such that the assignment of a telephone number can be one to one (e.g., one telephone number to one user account) or one to many (e.g., one telephone number to many user accounts).

In some embodiments, communication services platform 120 can dynamically assign or transfer the telephone numbers. For example, user account A may be assigned telephone number A. Telephone number A can be transferred and assigned to another user account Z and unassigned from user account A, or can be assigned to user account Z and user account A, for instance.

In some embodiments, messages can be dynamically routed or sent to and from different telephone numbers. For instance, a user account A may be assigned telephone number A. Telephone number A may have an area code corresponding to a first geographic location (e.g., Texas). User account A, via application 154 of client device 110A, sends, via communication services platform 120, a message A to an end user device. The end user device can be associated with a telephone number with an area code associated with a second geographic location (e.g., California). Communication services platform 120 can associate a telephone number with an area code for the second geographic location to the message conversation and send message A to end user device from the associated telephone number with the area code for the second geographic location. From the perspective of the end user device, the message A can appear to be sent from the telephone number with an area code for the second geographic location, rather than from the telephone number A with an area code for the first geographic location.

In some embodiments, the telephone number of the client device 110 (e.g., telephone number assigned to the client device 110 by the telecommunications carrier) can be different than the telephone number that is assigned to the user account associated with the client device 110. In some embodiments, the client device 110 may not have a telephone number assigned by a telecommunications carrier. For instance, the client device 110A may be a desktop computer. In some embodiments, the client device 110A can be identified by an internet protocol (IP) address and can send messages of the message conversation using a protocol such as HTTP over TCP/IP (transmission control protocol) or can place a voice call using a Voice over IP (VoIP) protocol (e.g., SIP) via application 154, for example.

Although embodiments of the disclosure are discussed in terms of communication service platforms, embodiments may also be generally applied to any type of platform, system or service.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user generalized where location information is obtained (such as to a city, ZIP code, or state level), so that a particular location of a user cannot be determined. Thus, the user may have control over how information is collected about the user and used by the communication services platform 120.

FIG. 2 illustrates an example platform 120 and an example resource pool engine 152, in accordance with some embodiments of the disclosure. As described above, platform 120 can be or otherwise include a communication services platform that facilitates or otherwise supports communications (e.g., messages, voice calls, etc.) associated with client device(s) 110 and directed to client device(s) 112. In some embodiments, platform 120 can be a SaaS platform. Resource pool engine 152 can manage and/or otherwise implement a communication resource pool associated with a user of platform (e.g., a user associated with a client device 110). Resource pool engine 152 can include a pool configuration module 212, a message content module 214, a channel selection module 216, and/or a message transmission module 214, in some embodiments. Details regarding resource pool engine 152 are provided with respect to FIGS. 2-5. As illustrated by FIG. 2, platform 120 and/or resource pool engine 152 may be connected to memory 250 (e.g., via network 104, via a bus, etc.). Memory 250 can include one or more portions of data store 106, in some embodiments. In other or similar embodiments, memory 250 can include or correspond to any memory of any component of system 100 and/or otherwise accessible to a component of system 100.

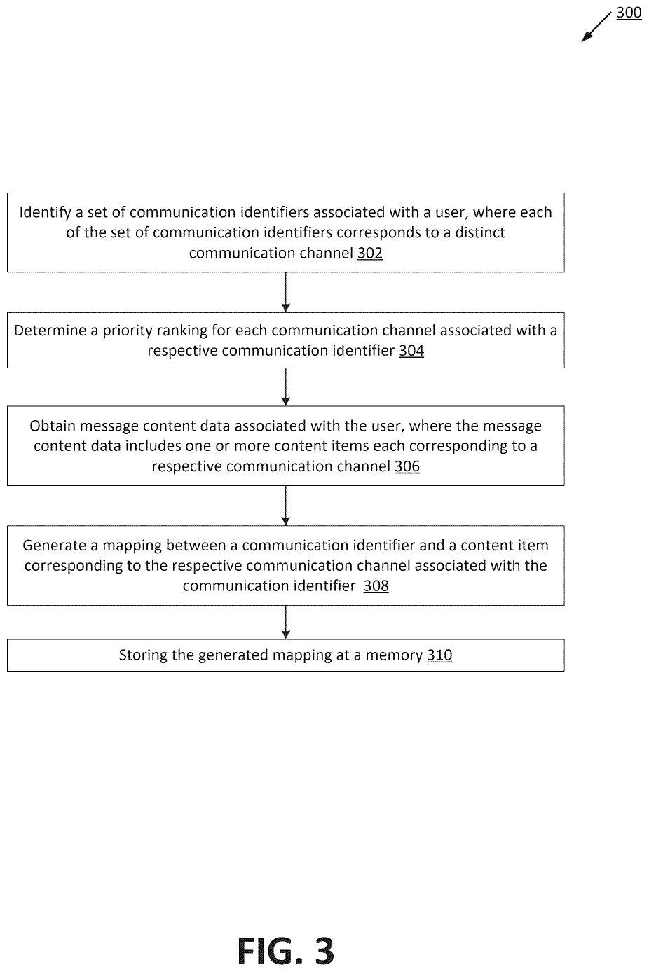

FIG. 3 is a flow diagram of an example method 300 for configuring a communication resource pool associated with a user, in accordance with some embodiments of the disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by platform 120 and/or resource pool engine 152. For example, some or all of the operations of method 300 can be performed by pool configuration module 212 and/or message content module 214.

At block 302, processing logic identifies a set of communication identifiers associated with a user, where each of the set of communication identifiers corresponds to a distinct communication channel. A communication identifier refers to a unique reference or address that identifies a specific account or device within a communication network. Examples of communication identifiers include phone numbers, email addresses, usernames or handles, internet protocol (IP) addresses, device identifiers (IDs), and so forth. As described above, each communication identifier can correspond a distinct communication channel 114. In an illustrative example, the set of communication identifiers associated with the user can include four communication identifiers, where the first communication identifier corresponds to a SMS communication channel, the second communication identifier corresponds to a MMS communication channel, the third communication identifier corresponds to an RCS communication channel, and the fourth communication identifier corresponds to an instant messaging communication channel.

In some embodiments, pool configuration module 212 of resource pool engine 152 can receive the set of communication identifiers from a client device 110 associated with the user. For example, pool configuration module 212 can provide a GUI to client device 110 that includes one or more GUI elements that enables the user to provide the set of communication identifiers. Upon detection that the user has provided the set of communication identifiers via the GUI, pool configuration module 212 can store the set of communication identifiers at memory 250 as communication resource pool data 252.

In other or similar embodiments, platform 120 may provision communication identifiers (e.g., phone numbers) to an account associated with the user and may assign the communication identifiers to various accounts associated with the user, as described above. In such embodiments, pool configuration module 212 may receive a request from a client device 110 to configure a communication resource pool for the user (e.g., based on a user interaction with one or more GUI elements of the provided GUI). Upon receiving the request, pool configuration module 212 can identify the provisioned communication identifiers for the user (e.g., from data store 106). Pool configuration module 212 can store the identified provisioned communication identifiers at memory 250 as communication resource pool data 252. In some embodiments, the user may provide one or more communication identifiers via the GUI element(s) of the provided GUI and pool configuration module 212 can identify one or more additional communication identifiers based on communication identifiers provisioned for the user.

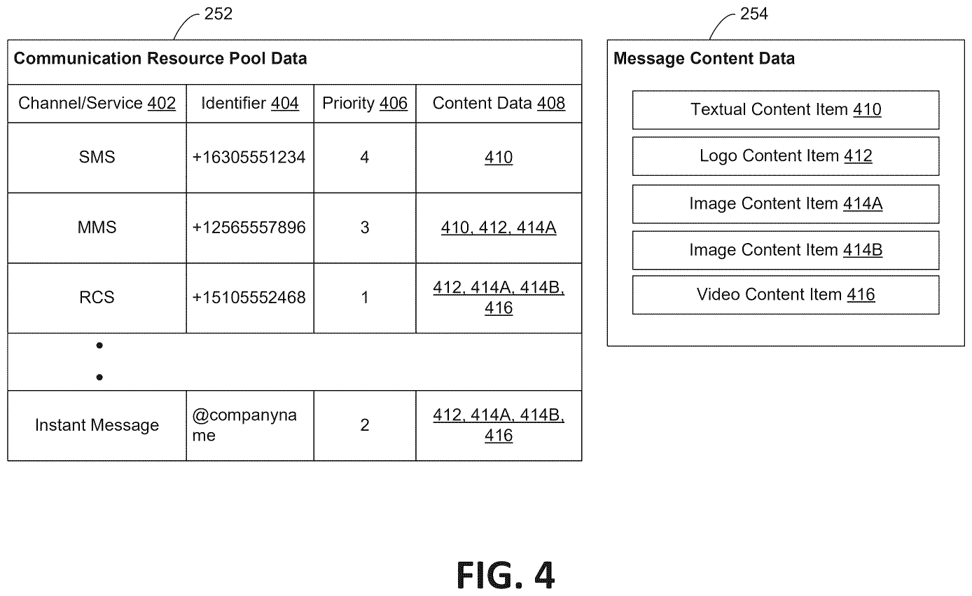

FIG. 4 illustrates example communication resource pool data 252 and example message content data 254, in accordance with some embodiments of the present disclosure. As illustrated by FIG. 4, communication resource pool data 252 can include an indication 402 of a communication channel and/or messaging service and a communication identifier 404 associated with the communication channel. For example, communication resource pool data 252 can include an indication 402 of a SMS communication channel and the first communication identifier for the SMS communication channel, an indication 402 of a MMS communication channel and the second communication identifier for the MMS communication channel, an indication 402 of an RCS communication channel and the third communication identifier for the RCS communication channel, and/or an indication 402 of an instant messaging channel and the fourth communication identifier 404 for the instant messaging channel. It should be noted that the mappings between channel indications 402 and the communication identifiers 404, as illustrated by FIG. 4, are provided for the purpose of example and illustration only. In some embodiments, communication resource pool data 252 can include additional or fewer identifiers 404 and/or identifiers 404 for other types of communication channels 114. For example, communication resource pool data 252 can include identifiers 404 for a push notification communication channel, an e-mail communication channel, a chatbot communication channel, and so forth. In other or similar embodiments, communication resource pool data 252 can include an indication 402 of a communication channel 114 and multiple communication identifiers 404 associated with the communication channel 114 (e.g., where each communication identifier 404 associated with a distinct geographic location).

Referring back to FIG. 3, at block 304, processing logic determines a priority ranking for each communication channel associated with a respective communication identifier. A priority ranking can indicate an order of preference or importance for transmission of messages via each communication channel 114 associated with communication resource pool data 252. The priority ranking for each communication channel 114 can indicate whether the channel 114 should be prioritized for transmission of messages. For example, a high priority ranking can indicate that a corresponding communication channel 114 is to be prioritized over other communication channels 114 (e.g., having lower priority rankings). In some embodiments, the user can provide the priority rankings for each communication channel 114 with the communication identifiers 404 (e.g., via the GUI). In other or similar embodiments, pool configuration module 212 can determine the priority rankings based on prioritization rules provided to platform 120 (e.g., by a developer or operator of platform 120). In yet other or similar embodiments, pool configuration module 212 can determine the priority rankings based on historical or experimental data associated with messages transmitted on behalf of the user or other users of platform 120.

Upon determining the priority ranking for each communication channel 114 of communication resource pool data 252, pool configuration module 212 can store the priority rankings with communication resource pool data 252 at memory 250. As illustrated in FIG. 4, communication resource pool data 252 can include a priority ranking 406 for each communication channel 114 and/or communication identifier 404 of communication resource pool data 252. For example, the RCS communication channel can be associated with a priority ranking 406 of “1” (e.g., a highest priority ranking), the instant message communication channel can be associated with a priority ranking 406 of “2” (e.g., a second highest priority ranking), the MMS communication channel can be associated with a priority ranking 406 of “3” (e.g., a third highest priority ranking), and the SMS communication channel can be associated with a priority ranking 406 of “4” (e.g., a lowest priority ranking).

It should be noted that the priority rankings of FIG. 4 are provided for purposes of example and illustration only. Communication resource pool data 252 can include different types of priority rankings 406, in other or similar embodiments. For example, the priority rankings 406 can be binary priority rankings that indicate whether the communication channels have a priority or do not have a priority. As indicated above, in some embodiments, communication resource pool data 252 can include an indication 402 for a communication channel 114 and multiple communication identifiers 404. In such embodiment, each communication identifier 404 for a respective communication channel 114 can have a common priority ranking 406 (e.g., each communication identifier 404 has the same priority ranking 406) or can have a distinct priority ranking 406 (e.g., a first communication identifier 404 for a communication channel 114 has a different priority ranking 406 than a second communication identifier 404 for the communication channel 114).

Referring back to FIG. 3, at block 306, processing logic obtains message content data associated with the user, where the message content data includes one or more message content items each corresponding to a respective communication channel. Message content module 214 of resource pool engine 152 can obtain the message content data 254. In some embodiments, the user of client device 110 can provide message content data 254 via the GUI provided by resource pool engine 252. The message content data 254 can include one or more content items, including but not limited to textual content items, logo content items (e.g., including a logo associated with the user), image content items, video content items, or other types of content items. In some embodiments, the GUI can include one or more GUI elements that enable the user to provide, upload, designate, or otherwise specify content items for inclusion in message content data 254. Upon detecting that the user has provided the content items, client device 110 can transmit the content items to platform 120 and message content module 214 can store the content items at memory 250 as message content data 254. FIG. 4 illustrates example message content data 254, which can include, for example, a textual content item 410, a logo content item 412, one or more image content items 414, and/or a video content item 416. It should be noted that content items illustrated by FIG. 4 are provided for purposes of example and illustration only. Message content data 254 can include any number of content items and/or any type of content items.

Referring back to FIG. 3, at block 308, processing logic generates a mapping between a communication identifier and a content item corresponding to the respective communication channel associated with the communication identifier. Message content module 214 can determine a communication channel 114 corresponding to each respective content item of message content data 254. In some embodiments, the user can provide an indication of the communication channel that is associated with a respective content item via one or more GUI elements of the GUI provided by platform 120. Message content module 214 can generate a mapping between the communication channel and the corresponding content item, as provided by the user. In some embodiments, the user can provide multiple versions of the same type of content item, where each version is to be associated with a distinct communication identifier 404. For example, the user can provide multiple image content items 414 (e.g., 414A, 414B), which each include different versions of images. The user can provide an indication of the communication identifier 404 and/or channel 114 for which messages including the respective image content items 414 are to be transmitted via the GUI, as described above. For instances, the user can provide an indication that image content item 414A is to be included in messages transmitted via the RCS communication channel to recipient devices located in a first geographical location (e.g., using a particular communication identifier 404 for the first location) and image content item 414B is to be included in messages transmitted via the RCS communication channel to recipient devices located in a second geographical location (e.g., using a particular communication identifier 404 for the second location).

In other or similar embodiments, message content module 214 can determine the communication channel 114 corresponding to each respective content item based on the content capabilities associated with the communication channel 114. For example, message content module 214 can determine, based on a content protocol associated with the SMS channel, that the SMS channel can only transmit messages including textual content items. Accordingly, message content module 214 can generate a mapping between the SMS channel and the textual content item 410. In another example, message content module 214 can determine, based on a content protocol associated with the RCS channel, that the RCS channel can transmit messages including logo content items 412, image content items 414, and/or video content items 416. Accordingly, message content module 214 can generate a mapping between the RCS channel and the logo content item 412, the image content items 414 (e.g., 414A and 414B), and the video content item 414. In yet another example, message content module 214 can determine, based on a content protocol associated with the MMS channel, that the MMS channel can transmit messages including textual content items 410, logo content items, and/or certain types of image content items 414. Image content item 414A may have a type that can be transmitted via the MMS channel, while image content item 414B may not have such type. Accordingly, message content module 214 can generate a mapping between the MMS channel and the textual content item 410, the logo content item 412, and/or image content item 414A. Message content module 214 can determine communication channels 114 corresponding to the content items of message content data 254 according to other criteria, in additional or alternative embodiments. For example, message content module 214 can determine communication channels 114 corresponding to the content items based on content policies for geographical locations of communication identifiers 404 for respective communication channels 114.

Referring back to FIG. 3, at block 310, processing logic stores the generated mapping at a memory. In some embodiments, message content module 214 can update communication resource pool data 252 to include the mapping between a communication channel 114 and corresponding content items. As illustrated by FIG. 4, message content module 214 can update communication resource pool data 252 to include a content data mapping 408 between the textual content item 410 and the SMS channel and the identifier 404 for the SMS communication channel. Such content data mapping 408 indicates that textual content item 410 is to be included in messages transmitted to recipient devices (e.g., client device 112) via the SMS communication channel. Message content module 214 can update communication resource pool data 252 to include mappings 408 between content items of message content data and each communication channel 114 and/or identifier 404 for the communication channels 114, as illustrated by FIG. 4. It should be noted that the mappings 408 of FIG. 4 are provided for purpose of example and illustration only. Message content module 214 can update communication resource pool data 252 to include the mappings 408 according to other techniques or formats, in accordance with embodiments of the present disclosure.

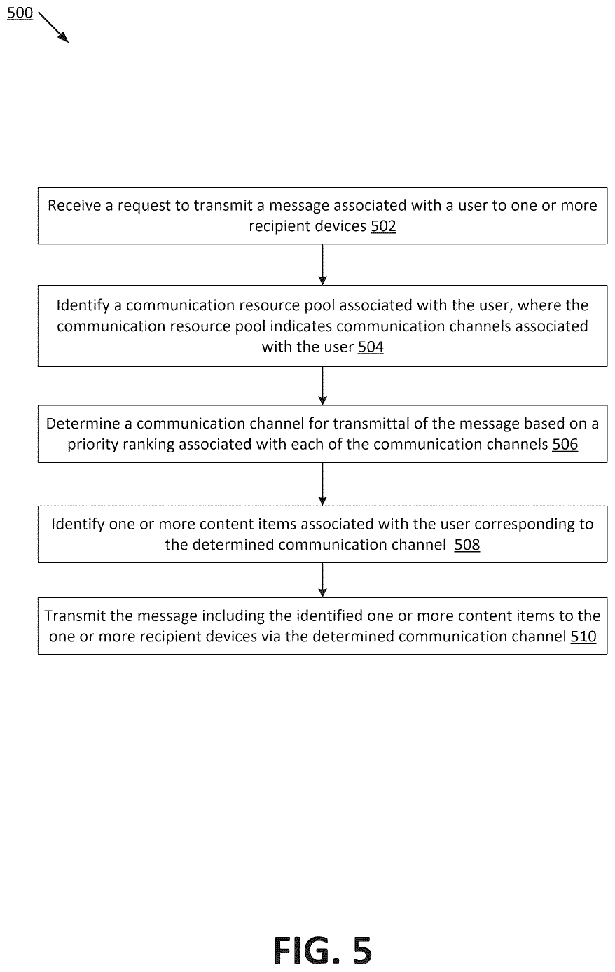

FIG. 5 is a flow diagram of an example method 500 for customized messaging across multiple communication channels, in accordance with some embodiments of the present disclosure. Method 500 can be performed by processing logic that can include hardware (circuitry, dedicated logic, etc.), software (e.g., instructions run on a processing device), or a combination thereof. In one implementation, some or all the operations of method 500 can be performed by one or more components of system 100 of FIG. 1. In some embodiments, some or all of the operations of method 500 can be performed by platform 120 and/or resource pool engine 152. For example, some or all of the operations of method 500 can be performed by channel selection module 216 and/or message transmission module 218.

At block 502, processing logic receives a request to transmit a message associated with a user to one or more recipient devices. In some embodiments, conversations system 122 can receive the request from a client device 110 to transmit messages to one or more of client devices 112. In some embodiments, the request can include one or more content items representing primary content for the message. The primary content can include content that is to be included in all messages, regardless of which communication channel 114 the message is transmitted. As will be seen herein, channel selection module 216 can identify content items of message content data 254 (e.g., provided by the user, as described above), which will be included in the message as supplementary content. In some embodiments, upon receiving the request, conversations system 122 can forward the request to resource pool engine 152. The request may indicate particular recipient devices (e.g., client devices 112) that are to receive the message, in some embodiments. In other or similar embodiments, the request may indicate characteristics of client devices 112 that are to receive the message (e.g., a geographic location of the client devices 112, an authentication status associated with the client devices 112, etc.). Conversations system 122 and/or resource pool engine 152 can identify the client devices 112 that satisfy the indicated characteristics, as described herein.

At block 504, processing logic identifies a communication resource pool associated with the user, where the communication resource pool indicates communication channels associated with the user. As indicated above, resource pool engine 152 can configure or otherwise maintain communication resource pools associated with multiple users. Channel selection module 216 can identify the communication resource pool data 252 for the communication resource pool associated with the user of the request by parsing memory 250 and determining (e.g., based on metadata) that communication resource pool data 252 corresponds to the user. Channel selection module 216 and/or other modules of resource pool engine 152 can identify communication resource pool data 252 according to other techniques.

At block 506, processing logic determines a communication channel for transmittal of the message based on a priority ranking associated with each of the communication channels. As described above, each communication channel 114 associated with communication resource pool data 252 may be associated with a priority ranking, which can indicate an order of preference or importance for transmission of messages via each communication channel 114 associated with communication resource pool data 252. In some embodiments, channel selection module 216 can identify the communication channel 114 having the a priority ranking that satisfies one or more priority criteria (e.g., is the highest priority ranking, is higher than priority rankings for other communication channels, etc.) and select such communication channel 114 for transmission of the message. In accordance with the example communication resource pool data 252 of FIG. 4, channel selection module can identify the RCS communication channel as having the priority ranking that satisfies the priority criteria and select the RCS communication channel for transmission of the message.

In some embodiments, channel selection module 216 can select the communication channel 114 for transmission of the message based on additional criteria, such as a message capability of a client device 112. For example, channel selection module 216 can obtain customer device data 256 associated with the client device 112 that is to receive the message. The customer device data 256 can indicate a message capability of the client device 112. The message capability can include a type of messages that the client device 112 is capable of receiving and/or a type of communication channel that can transmit message to the client device 112. In some embodiments, the customer device data 256 can indicate characteristic data associated with the client device 112, such as a manufacturer of the client device 112, an operating system of the client device 112, a version of the operating system of the client device 112, and so forth. Channel selection module 216 can determine the message capability of the client device 112 based on the characteristics data, in such embodiments. For example, channel selection module 216 can identify a message specification for client devices 112 of a particular manufacturer and can determine the message capability of the client device 112 based on the identified message specification.

In some embodiments, channel selection module 216 can obtain customer device data 256 by sending a request to a database associated with a client organization of platform 120 via at least one API call, in accordance with embodiments described above. Channel selection module 216 can receive a response corresponding to the request, which indicates the customer device data 256. Upon receiving the response, channel selection module 216 can store the customer service data 256 at memory 250.

As described above, channel selection module 216 can identify a particular communication channel (e.g., an RCS channel) of communication resource pool data as having a priority ranking that satisfies one or more priority criteria. However, channel selection module 216 can determine, based on customer device data 256, that a client device 112 that is to receive the message is not capable of receiving messages via the particular communication channel. In such embodiments, channel selection module 216 can identify the communication channel 114 having a priority ranking that does not satisfy the priority criteria but the client device 112 is capable of receiving messages from such communication channel 114. For example, channel selection module 216 can identify the communication channel 114 of communication resource pool data 252 that has the next highest priority ranking and of which the client device 112 is capable of receiving messages. Channel selection module 216 can select such identified communication channel 114 for transmission of the message. In accordance with the example of FIG. 4, channel selection module 216 can identify the instant message channel as having the next highest ranking and determine, based on customer device data 256, that the client device 112 is capable of receiving messages via the instant message channel. Accordingly, channel selection module 216 can select the instant message channel for transmission of the message to the client device 112.

In other or similar embodiments, channel selection module 216 can select the communication channel 114 for transmission of the message based on a historical messaging activity associated with a client device 112. Channel selection module 216 can obtain historical messaging data 258 associated with the client device 112, which can indicate the historical messaging activity associated with the client device 112. The historical messaging activity can include an indication of historical messages transmitted to the client device and a communication channel 114 used for transmission of the historical messages. In some embodiments, the historical messaging activity can additionally or alternatively include an indication of engagement of a user of client device 112 with respect to the historical messages. An engagement of the user can indicate a level of interaction the user has with the message, including actions like clicking on links, commenting, sharing, reacting, spending a particular amount of time reading the message, and so forth. In other or similar embodiments, the historical messaging data 258 can indicate a historical authentication status associated with client device 112. A historical authentication status can indicate whether the client device 112 has been authenticated (e.g., according to authentication protocols) to receive messages via a particular communication channel 114. In some embodiments, a client device 112 may be authenticated according to phone number verification protocols (e.g., where a user of the client device 112 confirms the phone number for the device through a one-time passcode (OTP) that is sent to the client device 112 and provided by the user via an application or system), device-based authentication token protocol, public key infrastructure protocol, biometric or pin verification protocol, OAuth or Single Sign-On (SSO) protocol, and so forth.

In some embodiments, channel selection module 216 can obtain historical messaging data 258 by sending a request to a database associated with a client organization of platform 120 via at least one API call, in accordance with embodiments described above. Channel selection module 216 can receive a response corresponding to the request, which indicates the historical messaging data 258. Upon receiving the response, channel selection module 216 can store the historical messaging data 258 at memory 250.

As described above, channel selection module 216 can identify a particular communication channel (e.g., an RCS channel) of communication resource pool data 252 as having a priority ranking that satisfies one or more priority criteria. However, channel selection module 216 can determine, based on the historical messaging activity of historical messaging data 258, that client device 112 is associated with a higher degree of engagement with messages transmitted via another communication channel of communication resource pool data 252 than the identified communication channel. In such embodiments, channel selection module 216 may select the other communication channel (e.g., having the higher degree of engagement) for transmission of the messages instead of the communication channel that satisfies the one or more priority criteria. In other or similar embodiments, channel selection module 216 can determine, based on a historical authentication status of historical messaging data 258, that the client device 112 has not been authenticated to receive messages via the identified communication channel (e.g., that satisfies the one or more priority criteria). In such embodiments, channel selection model 216 can select a communication channel 114 of communication resource pool data 252 for which client device 112 has been authenticated (e.g., or does not have authentication conditions or constraints) and/or has the next highest priority ranking for transmission of the message.

In additional or alternative embodiments, channel selection module 216 can use one or more artificial intelligence (AI) based techniques to identify a communication channel 114 for transmission of the message. For example, in some embodiments, resource pool engine 152 may maintain or otherwise have access to an AI model 260 that is trained to predict a communication channel 114 for transmission of a message based on given communication resource pool data 252, given customer device data 256, and/or given historical messaging data 258. In some embodiments, channel selection module 216 can obtain communication resource pool data 252, as described above, and provide communication resource pool data 252 as an input to the AI model 260. In additional or alternative embodiments, channel selection module 216 can obtain customer device data 256 and/or historical messaging data 258 and provide customer device data 256 and/or historical messaging data 258 as an additional input to the AI model 260. In yet additional or alternative embodiments, channel selection module 216 can obtain additional data (e.g., such as channel bandwidth data) for each channel 114 of communication resource pool data 252 and provide the additional data as additional input to the AI model 260.

Channel selection module 216 can obtain one or more outputs of the AI model 260, which can indicate each communication channel 114 of the communication resource pool data 252 and, for each indicated communication channel 114, a level of confidence that the message should be transmitted via such communication channel 114. The level of confidence for each communication channel 114 may be determined by the AI model 260 based on the priority rankings for each communication channel (e.g., as indicated by communication resource pool data 252), the device capability of a recipient client device 112 (e.g., as indicated by customer device data 256), the historical messaging activity of the recipient client device 112, and/or the historical authentication status of the recipient client device 112 (e.g., as indicated by historical messaging data 258). Channel selection module 216 can determine a communication channel 114 for transmission of the message by identifying the communication channel 114 having a level of confidence that satisfies one or more confidence criteria (e.g., exceeds a threshold level of confidence, is higher than levels of confidence for other communication channels 114, etc.).

The AI model 260 can be trained using a training data set that includes historical communication resource pool data, historical customer device data, and/or historical messaging activity data. For example, the training data set can include a training input that includes the historical communication resource pool data, historical customer device data, and/or historical messaging activity data and a target output for the training input, where the target output indicates a communication channel for transmission of a message in view of the historical communication resource pool data, historical customer device data, and/or historical messaging activity data. The AI model 260 can be composed of, e.g., a single level of linear or non-linear operations (e.g., a support vector machine (SVM) or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

At block 508, processing logic identifies one or more content items associated with the user corresponding to the determined communication channel. As described above, communication resource pool data 252 can include a mapping between each communication channel 114 of communication resource pool data 252 and content items of message content data 254 that correspond to each respective communication channel 114. Channel selection module 216 can determine which content items of message content data 254 correspond to the determined communication channel 114 based on the mapping and can retrieve the determined content items from message content data 254. In an illustrative example, channel selection module 216 can determine that the RCS communication channel is to be used for transmission of the message. Accordingly, channel selection module 216 can retrieve the logo content item 412, the image content item 414A, the image content item 414B, and/or video content item 416 from message content data 254, based on the content data mapping 408 of communication resource pool data 252.

At block 510, processing logic transmits the message including the identified one or more content items to the one or more recipient devices via the determined communication channel. Message transmission module 218 can update the message to include the primary content (e.g., included in the request of block 502) and the secondary content, which includes the content items retrieved at block 508. Message transmission module 218 can transmit the message to the client device(s) 112 via the determined communication channel 114 and/or can provide the message to conversations system 122 for transmission to the client device(s) 112 via the determined communication channel 114.

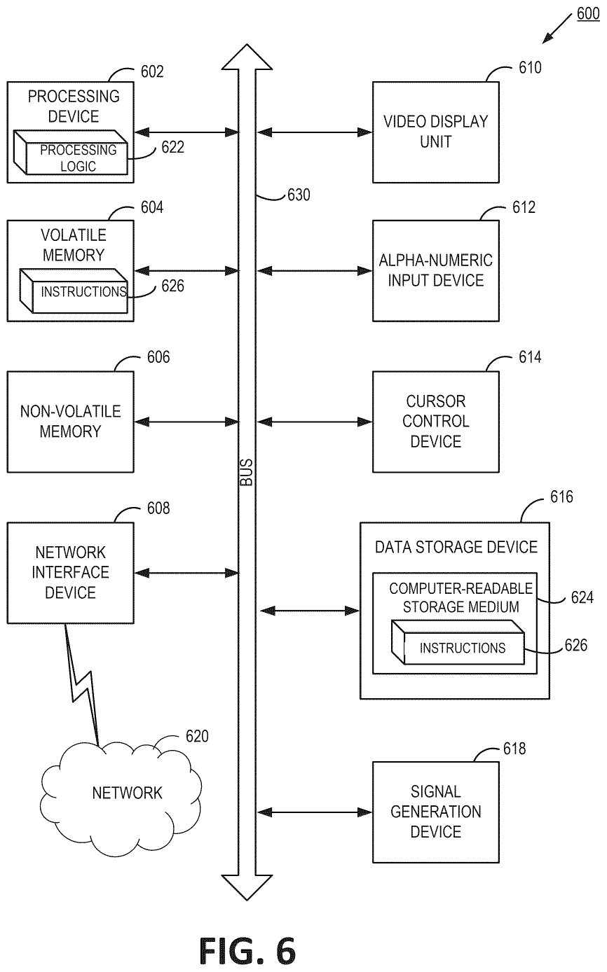

FIG. 6 is a block diagram illustrating an exemplary computer system 600, in accordance with some embodiments of the disclosure. The computer system 600 executes one or more sets of instructions that cause the machine to perform any one or more of the methodologies discussed herein. Set of instructions, instructions, and the like may refer to instructions that, when executed by computer system 600, cause computer system 600 to perform one or more operations of conversations system 122 and/or resource pool engine 152. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

The processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions of the system architecture 100 and conversations system 122 and/or resource pool engine 152 for performing the operations discussed herein.

The computer system 600 may further include a network interface device 622 that provides communication with other machines over a network 618, such as a local area network (LAN), an intranet, an extranet, or the Internet. The computer system 600 also may include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a non-transitory computer-readable storage medium 624 on which is stored the sets of instructions of the system architecture 100 of resource pool engine 152 embodying any one or more of the methodologies or functions described herein. The sets of instructions of the system architecture 100 and of resource pool engine 152 may also reside, completely or at least partially, within the main memory 604 and/or within the processing device 602 during execution thereof by the computer system 600, the main memory 604 and the processing device 602 also constituting computer-readable storage media. The sets of instructions may further be transmitted or received over the network 618 via the network interface device 622.

While the example of the computer-readable storage medium 624 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled. IN THE CLAIMS

What is claimed is:

1. A method, comprising:
receiving, at a software as a service (SaaS) platform, a request to transmit a message associated with a user to one or more recipient devices;
identifying a communication resource pool associated with the user, wherein the communication resource pool indicates a plurality of communication channels associated with the user, and wherein each of the plurality of communication channels is associated with a priority ranking;
determining a communication channel of the plurality of communication channels for transmittal of the message based on the priority ranking associated with each of the plurality of communication channels;
identifying, of a plurality of content items associated with the user, one or more content items corresponding to the determined communication channel; and
transmitting the message comprising the identified one or more content items to the one or more recipient devices via the determined communication channel.

2. The method of claim 1, wherein the plurality of communication channels comprises at least one of a short message service (SMS) communication channel, a multimedia messaging service (MMS) communication channel, a rich communication service (RCS) communication channel, a push notification communication channel, an electronic mail (e-mail) communication channel, an instant messaging communication channel, a social media communication channel, or a chatbot communication channel.

3. The method of claim 1, wherein determining the communication channel of the plurality of communication channels for transmittal of the message comprises:
responsive to determining that a first communication channel of the plurality of communication channels has a higher priority ranking than a second communication channel of the plurality of communication channels, selecting the first communication channel for transmittal of the message in view of the determination.

4. The method of claim 3, further comprising:
receiving a notification that the transmittal of the message via the first communication channel has failed;
identifying, of the plurality of content items associated with the user, one or more additional content items corresponding to the determined communication channel; and
transmitting the message comprising the identified one or more additional content items to the one or more recipient devices via the second communication channel.

5. The method of claim 1, wherein the priority ranking associated with each of the plurality of communication channels is, at least one of:
provided to the SaaS platform by the user, or
determined based on at least one of historical data associated with the SaaS platform or experimental data associated with the SaaS platform, or
defined by an operator of the SaaS platform.

6. The method of claim 1, wherein the communication channel for transmittal of the message is further determined based on at least one of a message capability of the one or more recipient devices or historical messaging data associated with the one or more recipient devices.

7. The method of claim 6, wherein a first communication channel of the plurality of communication channels is associated with a higher priority ranking than a second communication channel of the plurality of communication channel, and wherein determining the communication channel for transmittal of the message comprises:
determining, based on the message capability of the one or more recipient devices, that the one or more recipient devices are not capable of receiving the message via the first communication channel and are capable of receiving the message via the second communication channel; and
selecting the second communication channel for transmittal of the message in view of the determination.

8. The method of claim 6, wherein a first communication channel of the plurality of communication channels is associated with a higher priority ranking than a second communication channel of the plurality of communication channel, and wherein determining the communication channel for transmittal of the message comprises:
determining, based on the historical messaging data associated with the one or more recipient devices, that the second communication channel is a preferred communication channel associated with the one or more recipient devices; and
selecting the second communication channel for transmittal of the message in view of the determination.

9. The method of claim 6, further comprising:
sending, via at least one application programming interface (API) call, a request for the at least one of the message capability of the one or more recipient devices or the historical messaging data associated with the one or more recipient devices to a database associated with a client organization of the SaaS platform; and
receiving a response corresponding to the request, the response indicating the at least one of the message capability of the one or more recipient devices or the historical messaging data associated with the one or more recipient devices.

10. The method of claim 1, wherein the user is an entity requesting to send the message to a plurality of recipient devices comprising the one or more recipient devices, and each of the plurality of recipient devices is a respective user of the entity.

11. The method of claim 1, wherein the communication resource pool and the plurality of content items are provided to the SaaS platform by the user.

12. A system, comprising:
a memory device; and
a set of one or more processing devices coupled to the memory device, wherein the set of one or more processing devices are to perform operations comprising:
receiving, at a software as a service (SaaS) platform, a request to transmit a message associated with a user to one or more recipient devices;
identifying a communication resource pool associated with the user, wherein the communication resource pool indicates a plurality of communication channels associated with the user, and wherein each of the plurality of communication channels is associated with a priority ranking;
determining a communication channel of the plurality of communication channels for transmittal of the message based on the priority ranking associated with each of the plurality of communication channels;
identifying, of a plurality of content items associated with the user, one or more content items corresponding to the determined communication channel; and
transmitting the message comprising the identified one or more content items to the one or more recipient devices via the determined communication channel.

13. The system of claim 12, wherein the plurality of communication channels comprises at least one of a short message service (SMS) communication channel, a multimedia messaging service (MMS) communication channel, a rich communication service (RCS) communication channel, a push notification communication channel, an electronic mail (e-mail) communication channel, an instant messaging communication channel, a social media communication channel, or a chatbot communication channel.

14. The system of claim 12, wherein determining the communication channel of the plurality of communication channels for transmittal of the message comprises:
responsive to determining that a first communication channel of the plurality of communication channels has a higher priority ranking than a second communication channel of the plurality of communication channels, selecting the first communication channel for transmittal of the message in view of the determination.

15. The system of claim 14, wherein the operations further comprise:
receiving a notification that the transmittal of the message via the first communication channel has failed;
identifying, of the plurality of content items associated with the user, one or more additional content items corresponding to the determined communication channel; and
transmitting the message comprising the identified one or more additional content items to the one or more recipient devices via the second communication channel.

16. The system of claim 12, wherein the priority ranking associated with each of the plurality of communication channels is, at least one of:
provided to the SaaS platform by the user, or
determined based on at least one of historical data associated with the SaaS platform or experimental data associated with the SaaS platform, or
defined by an operator of the SaaS platform.

17. The system of claim 12, wherein the communication channel for transmittal of the message is further determined based on at least one of a message capability of the one or more recipient devices or historical messaging data associated with the one or more recipient devices.

18. The system of claim 17, wherein a first communication channel of the plurality of communication channels is associated with a higher priority ranking than a second communication channel of the plurality of communication channel, and wherein determining the communication channel for transmittal of the message comprises:
determining, based on the message capability of the one or more recipient devices, that the one or more recipient devices are not capable of receiving the message via the first communication channel and are capable of receiving the message via the second communication channel; and
selecting the second communication channel for transmittal of the message in view of the determination.

19. The system of claim 17, wherein a first communication channel of the plurality of communication channels is associated with a higher priority ranking than a second communication channel of the plurality of communication channel, and wherein determining the communication channel for transmittal of the message comprises:
determining, based on the historical messaging data associated with the one or more recipient devices, that the second communication channel is a preferred communication channel associated with the one or more recipient devices; and
selecting the second communication channel for transmittal of the message in view of the determination.

20. A non-transitory computer-readable medium comprising instructions that, responsive to execution by a set of one or more processing devices, cause the set of one or more processing devices to perform operations comprising:
receiving, at a software as a service (SaaS) platform, a request to transmit a message associated with a user to one or more recipient devices;
identifying a communication resource pool associated with the user, wherein the communication resource pool indicates a plurality of communication channels associated with the user, and wherein each of the plurality of communication channels is associated with a priority ranking;
determining a communication channel of the plurality of communication channels for transmittal of the message based on the priority ranking associated with each of the plurality of communication channels;
identifying, of a plurality of content items associated with the user, one or more content items corresponding to the determined communication channel; and
transmitting the message comprising the identified one or more content items to the one or more recipient devices via the determined communication channel.
